(19) United States
(12) Patent Application Publication
(10) Pub. No.: US 2011/0085585 A1
(43) Pub. Date: Apr. 14, 2011

(54) WIRELESS COMMUNICATION SYSTEM, WIRELESS COMMUNICATION APPARATUS, AND BUFFER CLEARING METHOD

(75) Inventors: Atsushi Matsumoto, Ishikawa (JP); Ayako Horiuchi, Kanagawa (JP); Seigo Nakao, Kanagawa (JP); Yoshiko Saito, Kanagawa (JP)

(73) Assignee: PANASONIC CORPORATION, Osaka (JP)

(21) Appl. No.: 12/994,374

(22) PCT Filed: Jun. 12, 2009
(86) PCT No.: PCT/JP2009/002676

§ 371 Date: Nov. 23, 2010

(30) Foreign Application Priority Data
Jun. 13, 2008 (JP) 2008-155820

(51) Int. Cl. H04B 7/17

(52) U.S. Cl. 375/211

(57) ABSTRACT

A wireless communication apparatus wherein the buffer size can be reduced without increasing the overhead of signalings. In this apparatus, a buffer (201) stores transport data. A radio receiving part (206) receives a response signal responsive to a transport data transmitted by the local apparatus; a response signal responsive to a transport data transmitted by another wireless communication apparatus; and relay data. A determining part (208) determines the smaller one of the two numbers: the number of ACK signals responsive to the transport data transmitted by the local apparatus and the number of ACK signals responsive to the transport data transmitted by the other wireless communication apparatus. The buffer (201) deletes transport data the number of which is equal to the difference between the number of ACK signals responsive to the transport data transmitted by the local apparatus and the number determined by the determining part (208). A network decoding part (209) uses both the relay data and the transport data stored in the buffer (201) to perform a network decoding, thereby acquiring data signals transmitted by the other wireless communication apparatus.

### TECHNICAL FIELD

The present invention relates to a radio communication system, a radio communication apparatus and a buffer clearing method.

### BACKGROUND ART

To enlarge the coverage area of each radio communication base station apparatus (hereinafter “BS,” standing for “Base Station”) in a radio communication system, a relay transmission technique is being studied where a radio communication relay station apparatus (hereinafter “RS,” standing for “Relay Station” or “Repeater Station”) is provided between a base station and a radio communication mobile station apparatus (hereinafter “MS” standing for “mobile station”) to communicate between the base station and the mobile station via a relay station.

In addition, application of a network coding technique to a relay station in a radio communication system is being studied. The network coding technique refers to a technique of allowing efficient relay by applying network coding to data received by a relay station from a base station and a mobile station.

For example, a relay station receives data S1 (MS)=1111 transmitted from a mobile station and data S1 (BS) 1010 transmitted from a base station. Then, the relay station performs XOR (exclusive OR) operation of S1 (MS) and S1 (BS). By this means, the relay station obtains the XOR operation result=0101. Then, the relay station transmits XOR operation result (0101), that is, a bit stream after network coding, to the mobile station and the base station at the same time, using the same channel (same resource).

The mobile station can obtain S1 (BS)=1010 transmitted by the base station by performing XOR operation of the bit stream (0101) transmitted from the relay station and S1 (MS)=1111 transmitted from the mobile station, as network decoding processing. Likewise, the base station can obtain S1 (MS)=1111 transmitted from the mobile station by performing XOR operation of the bit stream (0101) transmitted from the relay station and S1 (BS)=1010 transmitted from the base station, as network decoding processing. In this way, the mobile station and the base station can extract desired data, from data transmitted from the relay station using the same channel. Here, the mobile station and the base station have to store transmission data they have transmitted in order to extract desired data from data subjected to network coding in the relay station.

In addition, the relay station performs network coding on a pair of data (e.g. S1 (MS) and S1 (BS)) composed of transmission data (uplink data) from the mobile station to the base station and transmission data (downlink data) from the base station to the mobile station. Therefore, when there is a difference between the amount of data transmitted from the mobile station and the amount of data transmitted from the base station, the relay station performs network coding on only data sets made by paring transmission data from the mobile station and transmission data from the base station. That is, the relay station performs network coding on only the same number of sets of data as the data of the smaller amount of transmission data, as compared between the amount of transmission data from the mobile station and the amount of transmission data from the base station. Meanwhile, the relay station relays and transmits data not allowed to be subjected to network coding, using dedicated resources. That is, the relay station transmits an amount of transmission data equal to the difference between the amount of mobile station transmission data and the amount of base station transmission data using dedicated resources.

Here, the mobile station and the base station do not perform network decoding processing (XOR operation) on the data relayed and transmitted using dedicated resources (the data not subjected to network coding in the relay station). That is, of transmission data stored in the buffers in the mobile station and the base station, the transmission data relayed and transmitted using dedicated resources is not required. Therefore, the relay station transmits a buffer clear signal to command to remove data, which is relayed and transmitted using dedicated resources, to the mobile station and the base station. Then, the mobile station and the base station remove the data indicated by the buffer clear signal, from each buffer. For example, when relaying and transmitting S1 (MS) received from the mobile station to the base station using a dedicated resource, the relay station transmits a buffer clear signal to command to remove S1 (MS), to the mobile station. Then, the mobile station removes S1 (MS) stored in the buffer, according to the buffer clear signal transmitted from the relay station. By this means, it is possible to reduce the buffer size of the buffer held in the mobile station.

In addition, studies are underway to apply ARQ (Automatic Repeat reQuest) to data transmitted from a mobile station (or base station) to a relay station in a radio communication system adopting a relay and transmission technique. That is, a relay station feeds a response signal indicating the data error detection result back to a mobile station (or base station). To be more specific, a relay station performs a CRC (Cyclic Redundancy Check) check on data, and if CRC-OK, feeds an ACK (acknowledgement) signal back to a mobile station (or base station) as a response signal (there is no error), or if CRC-NG, feeds a NACK (negative acknowledgement) signal back to the mobile station (or base station) as a response signal (there is an error). In addition, for example, after receiving data, a relay station feeds a response signal to a mobile station (or base station) after a predetermined period of time has passed, and, when a NACK signal is fed back from the relay station, the mobile station (or base station) retransmits data to the relay station after a predetermined period of time has passed after receiving the NACK signal.

### CITATION LIST

### Non-Patent Literature

[NPL 1] Miki Yamamoto, the Journal of IEICE, “Network Coding”, pp. 111-116, Vol. 90, No. 2, 2007

### SUMMARY OF INVENTION

### Technical Problem

As described above, in order to reduce the buffer size of buffers held in a mobile station and a base station, a relay station has to transmit buffer clear signals to the mobile station and the base station. That is, signaling overhead is increased by the buffer clear signals.

It is therefore an object of the present invention to provide a radio communication system, a radio communication apparatus and a buffer clearing method to allow reduction in the buffer size without an increase in signaling overhead.

### Solution to Problem

The radio communication system according to the present invention adopts a configuration to include: a first radio communication apparatus; a second radio communication apparatus; and a radio communication relay station apparatus that performs relay and transmission between the first radio communication apparatus and the second radio communication apparatus, wherein: the radio communication relay station apparatus: performs error detection on first transmission data transmitted from the first radio communication apparatus and second transmission data transmitted from the second radio communication apparatus to generate an acknowledgement signal or a negative acknowledgement signal as a response signal; when a first response signal to the first transmission data and a second response signal to the second transmission data are both acknowledgement signals, performs network coding using the first transmission data and the second transmission data to generate relay data; and transmits the first response signal, the second response signal and the relay data to the first radio communication apparatus and the second radio communication apparatus, and the first radio communication apparatus: stores the first transmission data transmitted to the radio communication relay station apparatus in a buffer; receives the first response signal, the second response signal and the relay data; determines a smaller number, as compared between a number of first acknowledgement signals for the first transmission data and a number of second acknowledgement signals for the second transmission data; removes an amount of the first transmission data equal to a difference between the number of first acknowledgement signals and the smaller number, from the buffer; and obtains the second transmission data by performing network decoding using the relay data and the first transmission data stored in the buffer.

### Advantageous Effects of Invention

According to the present invention, it is possible to reduce the buffer size without an increase in signaling overhead.

### BRIEF DESCRIPTION OF DRAWINGS

FIG. 1 is a block diagram showing a configuration of a relay station according to an embodiment of the present invention;

FIG. 2 is a block diagram showing a configuration of a radio communication apparatus according to an embodiment of the present invention;

FIG. 3 is a sequence diagram (where there is no error) according to an embodiment of the present invention;

FIG. 4 is a drawing showing the number of ACK signals and the number of NACK signals received by a radio communication apparatus according to an embodiment of the present invention;

FIG. 5 is a drawing showing transmission data removal from a buffer according to an embodiment of the present invention;

FIG. 6 is a sequence diagram (where there is an error) according to an embodiment of the present invention;

FIG. 7 is a drawing showing the number of ACK signals and the number of NACK signals received by a radio communication apparatus according to an embodiment of the present invention; and

FIG. 8 is a drawing showing transmission data removal from a buffer according to an embodiment of the present invention.

### DESCRIPTION OF EMBODIMENTS

Now, embodiments of the present invention will be described in detail with reference to the accompanying drawings.

The radio communication system according to the present embodiment has radio communication apparatus A, radio communication apparatus B, and relay station 100 that performs relay and transmission between radio communication apparatus A and radio communication apparatus B. That is, in the radio communication system according to the present embodiment, two radio communication apparatuses (radio communication apparatus A and radio communication apparatus B) communicate via relay station 100. For example, two radio communication apparatuses are a base station and a mobile station, respectively.

In addition, the radio communication system according to the present invention applies ARQ to data from a radio communication apparatus to relay station 100. That is, relay station 100 according to the present embodiment performs a CRC check on received data, and if the received data has no error, feeds an ACK signal back to the radio communication apparatus, or if the received data has an error, feeds a NACK signal back to the radio communication apparatus. In this case, relay station 100 feeds a response signal back to the radio communication apparatus after a predetermined period of time has passed after relay station 100 receives data, and the radio communication apparatus receives the fed back response signal as a response signal directed to the radio communication apparatus. In addition, relay station 100 transmits response signals using resources allowing the response signal to be received by both radio communication apparatus A and radio communication apparatus B. For example, relay station 100 transmits response signals using the resources shared between radio communication apparatus A and radio communication apparatus B.

In addition, in the following descriptions, relay station 100 applies network coding to data transmitted from each of radio communication apparatus A and radio communication apparatus B. Then, relay station 100 transmits the data after network coding to radio communication apparatus A and radio communication apparatus B at the same time, using network coding resources reserved to transmit network coded data.

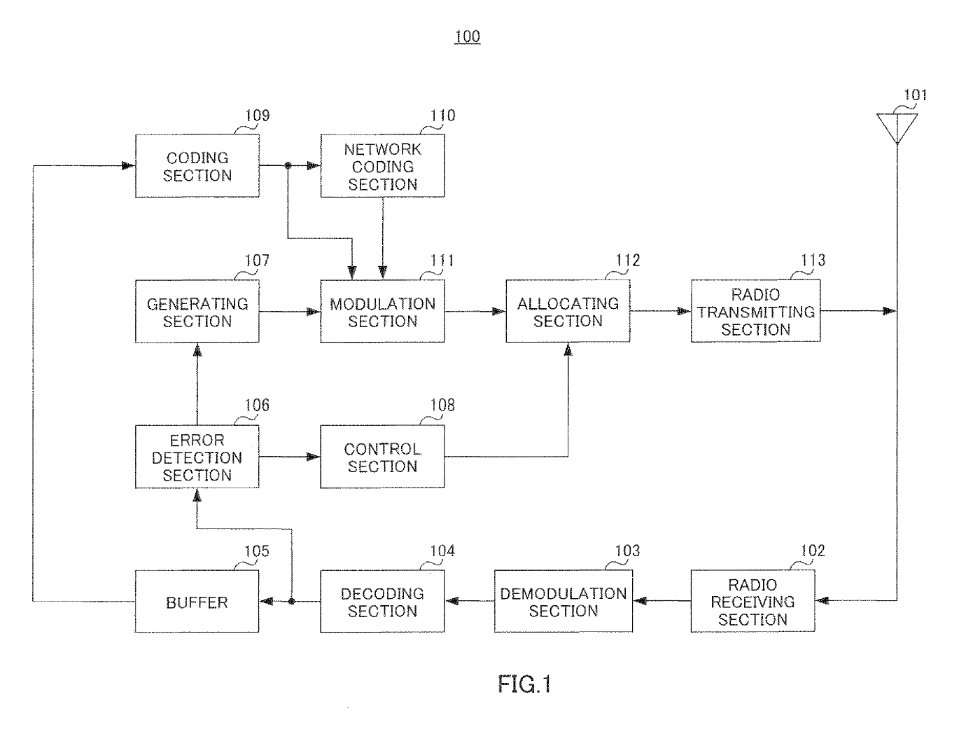

Now, the configuration of a relay station according to the present embodiment will be explained. FIG. 1 shows the configuration of relay station 100 according to the present embodiment.

In relay station 100, radio receiving section 102 receives data signals from a plurality of radio communication apparatuses via antenna 101, applies radio processing, including down-conversion and so forth, on these data signals and outputs data signals after radio processing to demodulation section 103.

Demodulation section 103 demodulates the data signals inputted from radio receiving section 102 and outputs a data signal after demodulation to decoding section 104.

Decoding section 104 decodes the data signals inputted from demodulation section 103 and outputs data signals after decoding to buffer 105 and error detection section 106.

Buffer 105 saves the data signals inputted from decoding section 104 only in a predetermined period of time, and outputs them to coding section 109.

Error detection section 106 detects whether or not there is an error in the data signals inputted from decoding section 104. Then, error detection section 106 outputs the detection result (the presence or absence of an error) to generating section 107 and control section 108.

Generating section 107 generates an ACK signal or NACK signal, as a response signal, based on the detection result inputted from error detection section 106. To be more specific, generating section 107 generates a NACK signal as a response signal when there is an error in data signals, or generates an ACK signal as a response signal when there is no error in data signals. Then, generating section 107 outputs the generated response signal to modulation section 111.

Control section 108 controls resources used to transmit signals, based on the detection result inputted from error detection section 106. For example, control section 108 determines the number of data signals subjected to network coding in network coding section 110 and the number of data signals not subjected to network coding in network coding section 110, based on the number of determination results for data signals transmitted from radio communication apparatus A and the number of determination results for data signals transmitted from radio communication apparatus B. To be more specific, control section 108 determines the smaller number as the number of data signals to be subjected to network coding, as compared between the number of data signals having no error from radio communication apparatus A and the number of data signals having no error from radio communication apparatus B. In addition, control section 108 determines the difference between the number of data signals having no error from radio communication apparatus A and the number of data signals having no error from radio communication apparatus B, as the number of data signals not subjected to network coding. Then, control section 108 determines the network cording resources to equal the number of data signals to be subjected to network coding, and also determines the dedicated resources to equal the number of data signals not to be subjected to network coding. In addition, control section 108 determines response signal resources to allocate response signals to. Then, control section 108 outputs control information indicating the determined resources to allocating section 112.

Coding section 109 encodes data signals inputted from buffer 105 and outputs coded data signals to network coding section 110 and modulation section 111. For example, when response signals to a data signal from radio communication apparatus A and a data signal from radio communication apparatus B are both ACK signals, coding section 109 outputs sets of data signals composed of the data signal from radio communication apparatus A and the data signal from radio communication apparatus B, to network coding section 110. Meanwhile, coding section 109 outputs, to modulation section 111, remaining data signals that cannot constitute a set of data signals, of data signals from radio communication apparatus A and radio communication apparatus B, that is, data signals not subjected to network coding.

Network coding section 110 performs network coding processing, namely XOR operation, using data signals from different radio communication apparatuses, which are inputted from coding section 109. For example, network coding section 110 performs XOR operation on data signals transmitted from radio communication apparatus A and data signals transmitted from radio communication apparatus B. Then, network coding section 110 outputs data signals after network coding (relay data) to modulation section 111.

Modulation section 111 modulates a response signal inputted from generating section 107, a coded data signal inputted from coding section 109 and data signal after network coding inputted from network coding section 110, and outputs each modulated signal to allocating section 112.

Allocating section 112 allocates each signal inputted from modulation section 111 to arbitrary transmission resources, according to control information inputted from control section 108. To be more specific, allocating section 112 allocates a response signal inputted from generating section 107 to the response signal resource indicated by control information. In addition, allocating section 112 allocates the data signal inputted from coding section 109 (data signal not subject to network coding) to the dedicated resource indicated by control information. In addition, allocating section 112 allocates the data signal inputted from network coding section 110 (data signal having been subjected to network coding) to the network coding resource indicated by control information. Here, the response signal resource is a resource shared between a plurality of radio communication apparatuses, that is, a resource to allow a plurality of radio communication apparatuses to receive response signals. Then, allocating section 112 outputs signals allocated to resources, respectively (i.e. a relay signal and a response signal) to radio transmitting section 113.

Radio transmitting section 113 performs radio processing, including up-conversion and so forth, on the signal inputted from allocating section 112, and relays and transmits the signal after radio processing from antenna 101.

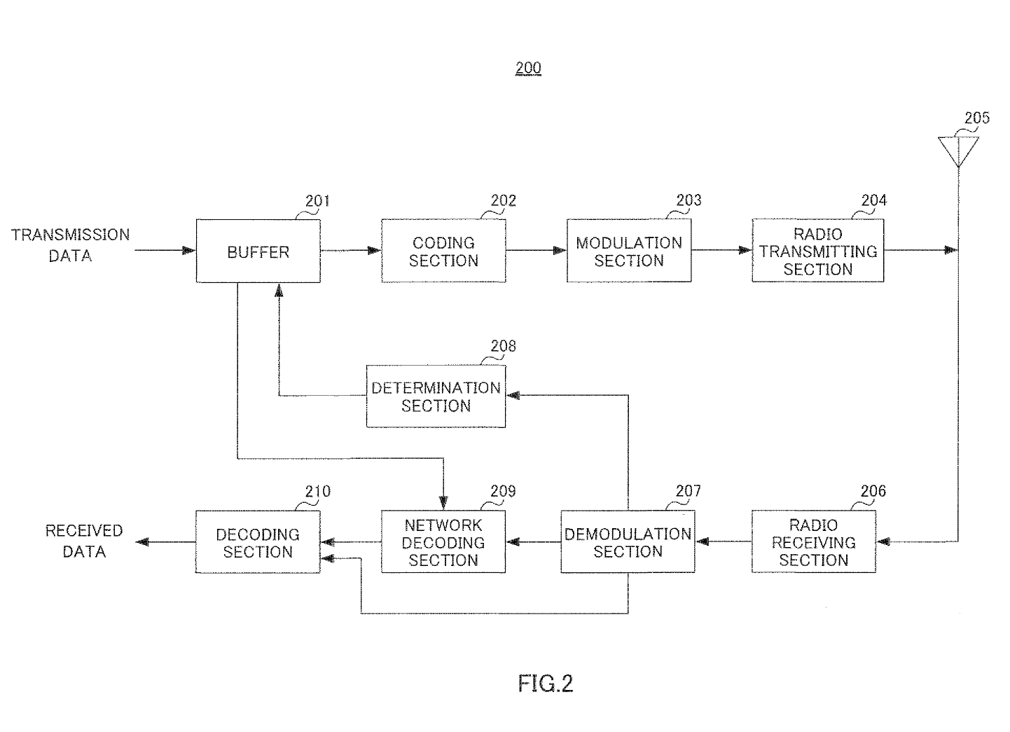

Next, the configuration of a radio communication apparatus according to the present embodiment will be described. FIG. 2 shows radio communication apparatus 200 according to the present embodiment. Both radio communication apparatus A and radio communication apparatus B in the radio communication system according to the present embodiment adopt the configuration shown in FIG. 2.

In radio communication apparatus 200, buffer 201 outputs transmission data to coding section 202 and stores transmission data. In addition, when network decoding section 209 extracts received data, buffer 201 outputs stored transmission data to network decoding section 209. Moreover, buffer 201 removes stored transmission data, based on a buffer clear signal inputted from determination section 208.

Coding section 202 encodes the transmission data inputted from buffer 201 and outputs coded transmission data to modulation section 203.

Modulation section 203 modulates the transmission data inputted from coding section 202 and outputs modulated transmission data to radio transmitting section 204.

Radio transmitting section 204 performs radio processing, including up-conversion and so forth, on the transmission data inputted from modulation section 203 and transmits transmission data after radio processing from antenna 205 to relay station 100 (FIG. 1).

Meanwhile, radio receiving section 206 receives a signal from relay station 100 via antenna 205, performs radio processing, including down-conversion and so forth, on the received signal and outputs a signal after radio processing to modulation section 207. Here, signals from relay station 100 include a response signal allocated to a response signal resource and relay data. In addition, relay data includes data signals allocated to network coding resources (data signals having been subjected to network coding) and data signals allocated to dedicated resources (data signals not having been subjected to network coding). Here, radio receiving section 206 receives a response signal (ACK signal or NACK signal) to the transmission data transmitted from radio communication apparatus 200, and a response signal to the transmission data transmitted from another radio communication apparatus, as response signals, using resources to allow to a plurality of radio communication apparatuses to receive response signals, that is, resources shared between radio communication apparatus 200 and the other radio communication apparatus.

Demodulation section 207 demodulates a signal inputted from radio receiving section 206, outputs a response signal to determination section 208, outputs a data signal allocated to the network coding resource (data signal having been subjected to network coding) to network decoding section 209 and outputs a data signal allocated to the dedicated resource (data signal not having been subjected to network coding) to decoding section 210.

For response signals (ACK signals or NACK signals) inputted from demodulation section 207, determination section 208 counts the number of response signals to transmission data transmitted from radio communication apparatus 200 (the number of response signals to radio communication apparatus 200) and the number of response signals to transmission data transmitted from the other radio communication apparatus. Then, based on the numbers of response signals counted, determination section 208 determines the amount of transmission data having been subjected to network coding in relay station 100 and the amount of transmission data having been transmitted using the dedicated resource from relay station 100, among the transmission data transmitted from radio communication apparatus 200. To be more specific, determination section 208 first determines the smaller number, as compared between the number of ACK signals for transmission data transmitted from radio communication apparatus 200 and the number of ACK signals for transmission data transmitted from the other radio communication apparatus. The number determined here is equal to the amount of transmission data subjected to network coding in relay station 100. For example, determination section 208 determines the amount of transmission data N_{NC} subjected to network coding, according to following equation 1.

Equation 1

N_{NC}=min(N_{A}^{ACK}, N_{B}^{ACK}) [1]

Here, the operator min (X, Y) is a function to return the smaller numeric value between two numeric values X and Y. In addition, N_{A}^{ACK} is the number of ACK signals of response signals to transmission data transmitted from radio communication apparatus 200 (e.g. radio communication apparatus A) and N_{B}^{ACK} is the number of ACK signals of response signals to transmission data transmitted from the other radio communication apparatus (e.g. radio communication apparatus B).

Next, determination section 208 determines the amount of transmission data having been transmitted using dedicated resources from relay station 100 (the amount of transmission data not having been subjected to network coding), based on the amount of transmission data N_{NC} determined. To be more specific, determination section 208 calculates the difference between the number of ACK signals N_{A}^{ACK} for transmission data transmitted from radio communication apparatus 200 and the amount N_{NC} determined using equation 1, and determines the calculation result as the amount of transmission data transmitted from relay station 100 using dedicated resources. For example, determination section 208 calculates the amount of transmission data N_{DC} transmitted using dedicated resources, according to following equation 2.

Equation 2

N_{DC}=N_{A}^{ACK}−N_{NC} [2]

That is, the calculated amount of transmission data N_{DC} is equal to the amount of transmission data not requiring network decoding processing. In other words, the amount of transmission data N_{DC} is equal to the amount of transmission data allowed to be removed, of transmission data stored in buffer 201. Therefore, determination section 208 outputs a buffer clear signal to command to remove N_{DC} transmission data, to buffer 201. That is, buffer 201 removes the same amount of transmission data as the difference between the number of ACK signals N_{A}^{ACK} to the transmission data transmitted from radio communication apparatus 200 and the amount N_{NC} determined by determination section 208. In other words, buffer 201 removes the same amount of transmission data as the amount of transmission data N_{DC} using dedicated resources from relay station 100.

Network decoding section 209 performs network decoding processing, namely XOR operation, using the data signals inputted from demodulation section 207 (data signals having been subjected to network coding) and the transmission data stored in buffer 201. Then, network decoding section 209 outputs the computation results, that is, the data signals transmitted from the other radio communication apparatus to decoding section 210.

Decoding section 210 decodes the data signals inputted from demodulation section 207 or the data signals inputted from network decoding section 209 to obtain received data.

Next, relay and transmission processing in the radio communication system according to the present embodiment will be explained. Here, radio communication apparatus A transmits two transmission data (S1(A) and S2(A)), and radio communication apparatus B transmits one transmission data S1(B). That is, the amount of data transmitted from radio communication apparatus A to radio communication apparatus B is greater than the amount of data transmitted from radio communication apparatus B to radio communication apparatus A. In addition, for ease of explanation, only transmission data removal processing in buffer 201 (buffer clear processing) in radio communication apparatus A will be explained, and buffer clear processing in buffer 201 in radio communication apparatus B will not be explained.

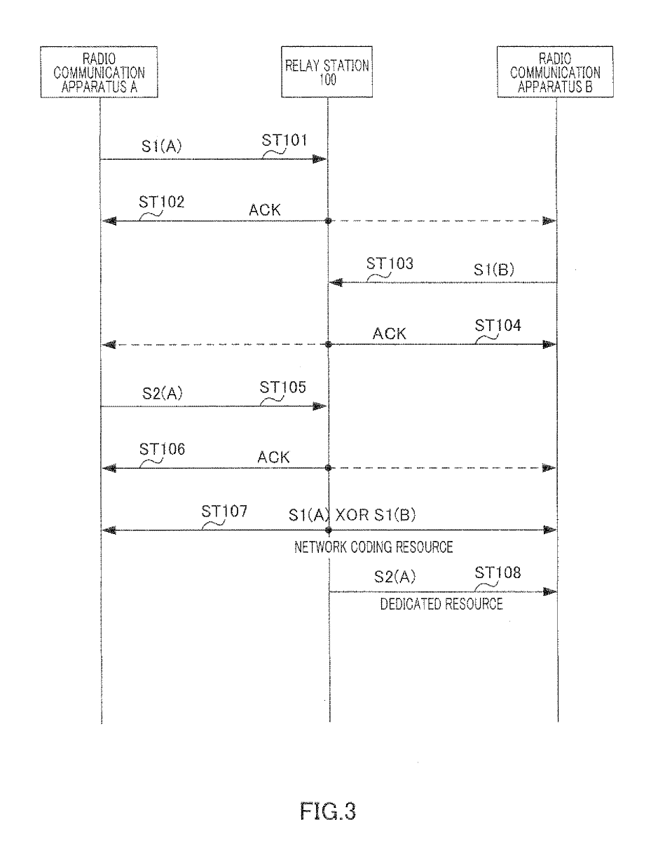

First, a case will be explained where, in relay station 100, there is no error in transmission data transmitted from each radio communication apparatus (FIG. 3).

In step (hereinafter “ST”) 101 in the sequence diagram shown in FIG. 3, radio communication apparatus A transmits S1(A) to relay station 100 and stores S1(A) in buffer 201 (FIG. 2).

Relay station 100 performs error detection on received S1(A). When S1(A) has no error, relay station 100 feeds an ACK signal for S1(A) back to radio communication apparatus A in ST 102. Determination section 208 in radio communication apparatus A counts the received ACK signal directed to radio communication apparatus A. Here, the ACK signal for S1(A) is transmitted using a resource shared between radio communication apparatus A and radio communication apparatus B, so that radio communication apparatus B is able to receive the ACK signal (the broken line arrow in ST 102 in FIG. 3) directed to radio communication apparatus A. That is, relay station 100 transmits the response signal directed to radio communication apparatus A, to radio communication apparatus A and also radio communication apparatus B.

In ST 103, radio communication apparatus B transmits S1(B) to relay station 100.

In ST 104, relay station 100 performs error detection on the received S1(B), and, when S1(B) has no error, feeds an ACK signal for S1(B) back to radio communication apparatus B. Here, like in ST 102, the ACK signal for S1(B) is transmitted using a resource shared between radio communication apparatus A and radio communication apparatus B, so that radio communication apparatus A is able to receive the ACK signal (the broken line arrow in ST 104 in FIG. 3) directed to radio communication apparatus B. That is, relay station 100 transmits the response signal directed to radio communication apparatus B, to radio communication apparatus B and also radio communication apparatus A. Then, determination section 208 in radio communication apparatus A counts the received ACK signal directed to the other radio communication apparatus (radio communication apparatus B here).

In ST 105, radio communication apparatus A transmits S2(A) to relay station 100 and stores it in buffer 201.

In ST 106, relay station 100 performs error detection on received S2(A), and, when S2(A) has no error, feeds an ACK signal for S2(A) back to radio communication apparatus A. Then, detecting section 208 in radio communication apparatus A counts the received ACK signal directed to radio communication apparatus A. In addition, like in ST 102, radio communication apparatus B receives the ACK signal (the broken line arrow in ST 106 in FIG. 3) directed to radio communication apparatus A.

As shown in FIG. 3, while the amount of transmission data transmitted from radio communication apparatus A and received by relay station 100 with no error is two (S1(A) and S2(A)), the amount of transmission data transmitted from radio communication apparatus B and received by relay station 100 with no error is one (S1(B)). Consequently, in relay station 100, there is one pair of data allowed to be composed of the transmission data from radio communication apparatus A and the transmission data from radio communication apparatus B. Therefore, in ST 107, relay station 100 performs network coding (XOR operation) using S1(A) transmitted from radio communication apparatus A and S1(B) transmitted from radio communication apparatus B. That is, relay station 100 performs network coding (XOR operation) on a pair of data composed of transmission data from radio communication apparatus A and transmission data from radio communication apparatus B. Then, relay station 100 transmits transmission data (S1(A)XORS1(B)) after network coding, to radio communication apparatus A and radio communication apparatus B at the same time, using a network coding resource.

S2(A) transmitted from radio communication apparatus A, which is data other than the pair of data (S1(A) and S1(B)) having been subjected to network coding in ST 107, cannot constitute a pair of data with transmission data from the other radio communication apparatus. Therefore, in ST 108, relay station 100 transmits S2(A) to radio communication apparatus B using a dedicated resource.

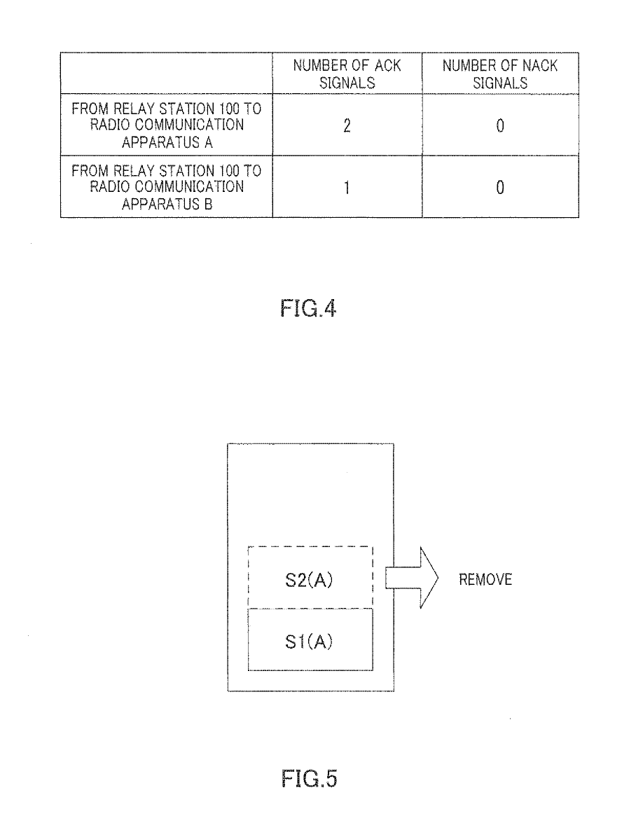

FIG. 4 shows the number of ACK signals and the number of NACK signals counted in determination section 208 in radio communication apparatus A. To be more specific, since radio communication apparatus A receives ACK signals directed to radio communication apparatus A in ST 102 and ST 106 shown in FIG. 3, the number of ACK signals from relay station 100 to radio communication apparatus A (the number of ACK signals directed to radio communication apparatus A), counted in determination section 208, is two. Likewise, since radio communication apparatus A receives an ACK signal directed to radio communication apparatus B in ST 104 shown in FIG. 3, the number of ACK signals from relay station 100 to radio communication apparatus B (the number of ACK signals directed to radio communication apparatus B), counted in determination section 208, is one. In addition, the number of NACK signals from relay station 100 to radio communication apparatus A (the number of NACK signals directed to radio communication apparatus A) and the number of NACK signals from relay station 100 to radio communication apparatus B (the number of NACK signals directed to radio communication apparatus B), counted in determination section 208, are zero.

Therefore, determination section 208 determines the amount of transmission data N_{NC}, which has been subjected to network coding in relay station 100, is 1(=min(2,1)), according to equation 1. In addition, determination section 208 determines the amount of transmission data N_{DC}, which has been transmitted using dedicated resources, is 1(−2−1), according to equation 2. That is the amount of transmission data removed from buffer 201 is one. Here, radio communication apparatus A regards S1(A) first transmitted as network coded transmission data, and regards S2(A) subsequent transmitted as transmission data transmitted using the dedicated resource. That is, transmission data not need to be saved in buffer 201 in radio communication apparatus A is S2(A). Therefore, determination section 208 outputs a buffer clear signal commanding to remove transmission data (S2(A)), to buffer 201.

As shown in FIG. 5, buffer 201 in radio communication apparatus A stores S1(A) transmitted in ST 101 and S2(A) transmitted in ST 105 shown in FIG. 3. Here, upon receiving the buffer clear signal commanding to remove S2(A) from determination section 208, as input, buffer 201 removes S2(A) as shown in FIG. 5. That is, buffer 201 stores only S1(A). In other words, buffer 201 is placed in a state to store only transmission data having been subjected to network coding in relay station 100.

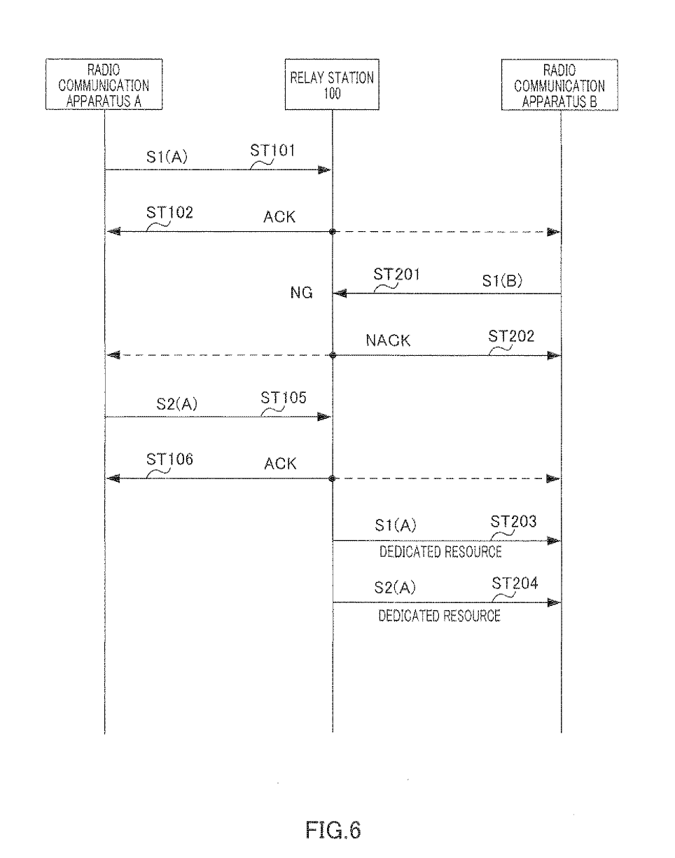

Next, a case will be explained where there is an error in the transmission data from radio communication apparatus B in relay station 100 (FIG. 6). Here, the same operations as in the sequence diagram shown in FIG. 3 will not be explained.

In ST 201 in the sequence diagram shown in FIG. 6, radio communication apparatus B transmits S1(B) to relay station 100. Relay station 100 performs error detection on the received S1(B). Here, when S1(B) has an error (NG), relay station 100 feeds a NACK signal for S1(B) back to radio communication apparatus B in ST 202. At this time, radio communication apparatus A receives the NACK signal (the broken line arrow in ST 202 in FIG. 6) directed to radio communication apparatus B, and determination section 208 in radio communication apparatus A counts the received NACK signal directed to radio communication apparatus B.

As shown in FIG. 6, while the amount of transmission data transmitted from radio communication apparatus A and received by relay station 100 with no error is two (S1(A) and S2(A)), the amount of transmission data transmitted from radio communication apparatus B and received by relay station 100 with no error is zero. That is, in FIG. 6, there is no transmission data from radio communication apparatus B to radio communication apparatus A, and only the transmission data from radio communication apparatus A to radio communication apparatus B is relayed by relay station 100. Therefore, relay station 100 cannot form a pair of data subjected to network coding. Consequently, relay station 100 transmits S1(A) to radio communication apparatus B using a dedicated resource in ST 203, and transmits S2(A) to radio communication apparatus B using a dedicated resource.

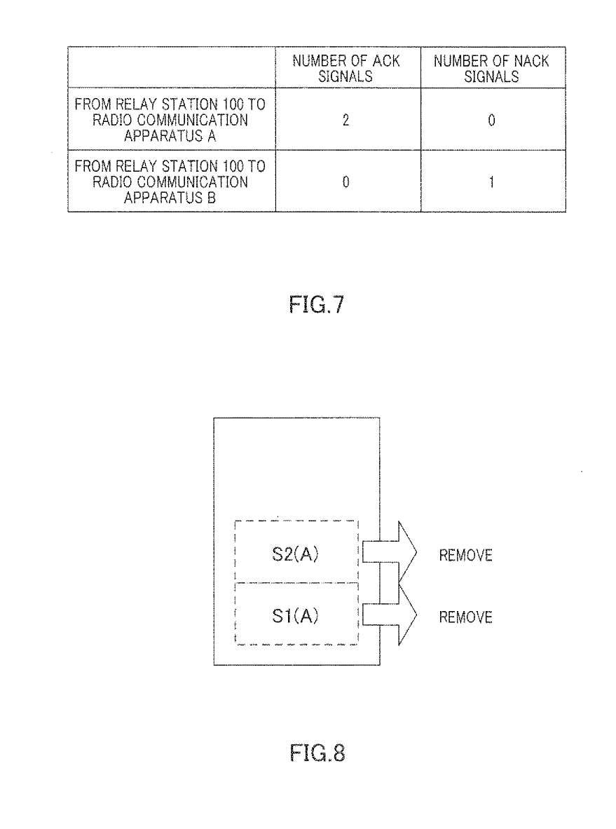

FIG. 7 shows the number of ACK signals and the number of NACK signals counted in determination section 208 in radio communication apparatus A. To be more specific, the number of ACK signals directed to radio communication apparatus A, counted in determination section 208, is two, like in FIG. 4. In addition, since a NACK signal directed to radio communication apparatus B is received in ST 202 shown in FIG. 6, the number of NACK signals from relay station 100 to radio communication apparatus B (the number of NACK signals directed to radio communication apparatus B), counted by determination section 208 in radio communication apparatus A, is one. In addition, the number of NACK signals from relay station 100 to radio communication apparatus A (the number of NACK signals directed to radio communication apparatus A), and the number of ACK signals from relay station 100 to radio communication apparatus B (the number of ACK signals directed to radio communication apparatus B) are zero.

Therefore, determination section 208 determines the amount of transmission data N_{NC} having been subjected to network coding in relay station 100 is 0 (=min(2,0)), according to equation 1. In addition, determination section 208 determines the amount of transmission data N_{DC} having been transmitted using a dedicated resource is 2(=2−0), based on equation 2. That is, the amount of transmission data required to be saved in buffer 201 in radio communication apparatus A for network decoding processing is zero, and the amount of transmission data to be removed from buffer 201 (the amount of transmission data N_{DC} transmitted using dedicated resources) is two. Accordingly, determination section 208 outputs a buffer clear signal commanding to remove two transmission data (S1(A) and S2(A)), to buffer 201.

As shown in FIG. 8, buffer 201 in radio communication apparatus A stores S1(A) and S2(A) like in FIG. 5. Here, upon receiving the buffer clear signal commanding to remove S1(A) and S2(A) from determination section 208, as input, buffer 201 removes S1(A) and S2(A), as shown in FIG. 8. By this means, buffer 201 stores no transmission data.

In this way, radio communication apparatus A is able to know the amount of transmission data subjected to network coding in relay station 100, whether there is an error or no error in transmission data from relay station 100. In addition, radio communication apparatus A is able to know the amount of transmission data not subjected to network coding in relay station 100 and relayed using dedicated resources, that is, the amount of transmission data not required to be stored in buffer 201 in radio communication apparatus A. By this means, radio communication apparatus A is able to remove transmission data not need to be subjected to network decoding processing from buffer 201, without signaling from relay station 100.

As described above, according to the present embodiment, a radio communication apparatus counts the number of ACK signals directed to the radio communication apparatus and the number of ACK signals directed to another radio communication apparatus, and determines the amount of transmission data having been subjected to network coding in a relay station and the amount of transmission data having been transmitted using dedicated resources (the amount of transmission data not subjected to network coding). By this means, radio communication apparatuses are able to remove unnecessary transmission data stored in a buffer (transmission data having been transmitted using dedicated resources) from their buffers, without receiving signaling from the relay station. Thus, according to the present embodiment, it is possible to remove unnecessary transmission data from a buffer without an increase in signaling overhead, and therefore reduce the size of a buffer.

Here, with the present embodiment, although the buffer clearing method in radio communication apparatus A has been explained, it is possible to produce the same effect in radio communication apparatus B by performing the same processing as in radio communication apparatus A.

In addition, it is possible to provide radio communication apparatus 200 according to the present embodiment in a base station or a mobile station. This allows a base station and a mobile station to produce the same function and effect as in the above-descriptions. Here, a mobile station is required to reduce its size and weight, and therefore its buffer size is limited as compared to the buffer size allowed to be held in a base station. Therefore, a radio communication apparatus according to the present invention is provided in a mobile station, so that it is possible to reduce the buffer size more and improve the effect of the present invention.

In addition, with the present embodiment, a case has been explained where response signals are transmitted using resources shared between a plurality of radio communication apparatuses. For example, network coding resources reserved to communicate network coded relay data may be used, as resources shared between a plurality of communication apparatuses.

Moreover, with the present embodiment, a case has been explained where determination section 208 (FIG. 2) determines the amount of transmission data N_{NC} subjected to network coding and the amount of transmission data N_{DC} transmitted using dedicated resources, based on the number of received ACK signals, as shown in equation 1 and equation 2. However, according to the present invention, determination section 208 may calculate the number of ACK signals using received NACK signals, and determine the amount of transmission data N_{NC} subjected to network coding and the amount of transmission data N_{DC} transmitted using dedicated resources, according to equation 1 and equation 2. To be more specific, the number of ACK signals N_{A}^{ACK} directed to radio communication apparatus A shown in equation 1 and equation 2 is calculated by following equation 3.

Equation 3

N_{A}^{ACK}=the amount of transmission data transmitted from radio communication apparatus A−N_{A}^{NACK} [3]

Here, N_{A}^{NACK} is the number of NACK signals directed to radio communication apparatus A. That is, in radio communication apparatus A, the number of ACK signals for transmission data transmitted from radio communication apparatus A is equal to the difference between the amount of transmission data transmitted from radio communication apparatus A and the number of NACK signals for the transmission data transmitted from radio communication apparatus A. This enables radio communication apparatus A to determine the amount of transmission data to be removed from the buffer, based on received NACK signals.

Moreover, in the present embodiment, a relay station may designate a buffer clearing method in advance to a radio communication apparatus (e.g. a mobile station and a base station), and each radio communication apparatus corrects buffer clear processing, based on a response signal (an ACK signal or NACK signal) from the relay station. For example, a relay station notifies a radio communication apparatus (e.g. mobile station) in advance that relay transmission to perform network coding and relay transmission not to perform network coding (relay transmission using a dedicated resource) are alternately performed on transmission data transmitted from the radio communication apparatus (e.g. mobile station). In this case, for example, the relay station receives two transmission data items from the radio communication apparatus (e.g. mobile station) and receives one transmission data item from another radio communication apparatus (e.g. base station). Here, assume that transmission data from each radio communication apparatus is transmitted to a relay station with no error. At this time, since the relay station performs network coding on every other transmission data from the radio communication apparatus (e.g. mobile station), the radio communication apparatus (e.g. mobile station) may remove every other transmission data stored in the buffer.

Here, when there is an error in any of transmission data transmitted from the radio communication apparatus (e.g. mobile station), the relay station relays and transmits one transmission data item to each of the radio communication apparatus (e.g. mobile station) and another communication apparatus (e.g. base station). That is, relay station performs network coding on only one pair of data. Therefore, when receiving a NACK signal directed to the radio communication apparatus (e.g. mobile station), the radio communication apparatus corrects the buffer clearing method to stop removing transmission data stored in the buffer.

On the other hand, when there is an error in the transmission data transmitted from another radio communication apparatus (e.g. base station), the relay station relays and transmits two data items from the radio communication apparatus (e.g. mobile station). That is, the relay station performs only relay transmission using dedicated resources but does not perform network cording. Therefore, when receiving a NACK signal directed to another radio communication apparatus (e.g. base station), the radio communication apparatus (e.g. mobile station) corrects the buffer clearing method to remove all the transmission data stored in the buffer.

By this means, even if a buffer clearing method is designated to each radio communication apparatus in advance, and an error occurs in a relay station, a radio communication apparatus corrects the buffer clearing method according to a response signal from the relay station, so that it is possible to reduce the size of a buffer without an increase in signaling overhead, in the same way as in the present invention.

Moreover, with the above-described embodiment, a ease has been explained where a relay station performs network coding on coded relay data. However, according to the present invention, a relay station may encode network coded relay data.

In addition, with the above-described embodiment, a case may be possible where a relay station does not perform on data required to be retransmitted and will transmit the data using dedicated resources.

Moreover, in the above-described embodiment, the buffer clearing method based on ACK/NACK signals. However, according to the present invention, a NDI (new data indicator) indicating whether data is new data or retransmission data may be used, instead of ACK/NACK signals.

Moreover, in the above-described embodiment, a base station may be referred to as “Node B” and “eNode B (evolved Node B)” and a mobile station may be referred to as “UE”. Moreover, in the above-described embodiment, a relay station may be referred to as “RN (relay node)”, “repeater”, “sub-base station” “cluster head” and so forth.

Also, although cases have been described with the above embodiment as examples where the present invention is configured by hardware, the present invention can also be realized by software.

Each function block employed in the description of each of the aforementioned embodiments may typically be implemented as an LSI constituted by an integrated circuit. These may be individual chips or partially or totally contained on a single chip.

“LSI” is adopted here but this may also be referred to as “IC,” “system LSI,” “super LSI,” or “ultra LSI” depending on differing extents of integration.

Further, the method of circuit integration is not limited to LSI's, and implementation using dedicated circuitry or general purpose processors is also possible. After LSI manufacture, utilization of a programmable FPGA (Field Programmable Gate Array) or a reconfigurable processor where connections and settings of circuit cells within an LSI can be reconfigured is also possible.

Further, if integrated circuit technology comes out to replace LSI's as a result of the advancement of semiconductor technology or a derivative other technology, it is naturally also possible to carry out function block integration using this technology. Application of biotechnology is also possible.

The disclosure of Japanese Patent Application No. 2008-155820, filed on Jun. 13, 2008, including the specification, drawings and abstract, is incorporated herein by reference in its entirety.

### INDUSTRIAL APPLICABILITY

The present invention is applicable to a radio communication system and so forth in which a plurality of radio communication apparatuses perform radio communication via a relay station.

1-8. (canceled)

9. A relay station apparatus that performs relay and transmission between a first radio communication apparatus and a second radio communication apparatus, the relay station apparatus comprising:
a generating section that performs error detection on first transmission data transmitted from the first radio communication apparatus and second transmission data transmitted from the second radio communication apparatus, to generate an acknowledgement signal or a negative acknowledgement signal as a response signal;
a coding section that, when a first response signal corresponding to the first transmission data and a second response signal corresponding to the second transmission data are both acknowledgement signals, performs network coding using the first transmission data and the second transmission data to generate relay data; and
a transmission section that transmits the first response signal, the second response signal and the relay data to the first radio communication apparatus and the second radio communication apparatus.

10. The relay station apparatus according to claim 9, wherein the transmission section transmits the first response signal and the second response signal using a resource shared between the first radio communication apparatus and the second radio communication apparatus.

11. The relay station apparatus according to claim 9, wherein the transmission section transmits the first response signal and the second response signal using a resource reserved to transmit the relay data having been subjected to network coding,

12. A radio communication apparatus that communicates with another radio communication apparatus, via a relay station apparatus which generates relay data by performing network coding using first transmission data transmitted from the radio communication apparatus and second transmission data transmitted from the other radio communication apparatus, the radio communication apparatus comprising:
a buffer that stores the first transmission data;
a reception section that receives a first response signal corresponding to the first transmission data, a second response signal corresponding to the second transmission data and the relay data;
a determination section that determines a smaller number, as compared between a number of a first acknowledgement signals for the first transmission data and a number of second acknowledgement signals for the second transmission data;
a removing section that removes an amount of the first transmission data equal to a difference between the number of first acknowledgement signals and the smaller number; and
a decoding section that performs network decoding using the relay data and the first transmission data stored in the buffer to obtain the second transmission data.

13. The radio communication apparatus according to claim 12, wherein the reception section receives the first response signal and the second response signal using a resource shared between the radio communication apparatus and the other radio communication apparatus.

14. The radio communication apparatus according to claim 12, wherein the reception section receives the first response signal and the second response signal using a resource reserved to transmit the relay data having been subjected to network coding.

15. The radio communication apparatus according to claim 12, wherein the radio communication apparatus is a radio communication base station apparatus or a radio communication mobile station apparatus.

16. A buffer clearing method in a radio communication apparatus that communicates with another radio communication apparatus, via a relay station apparatus which generates relay data by performing network coding using first transmission data transmitted from the radio communication apparatus and second transmission data transmitted from the other radio communication apparatus, the buffer clearing method comprising:
determining a smaller number, as compared between a number of first acknowledgement signals for the first transmission data and a number of second acknowledgement signals for the second transmission data; and
removing an amount of the first transmission data equal to a difference between the number of first acknowledgement signals and the smaller number, from the first transmission data stored in a buffer.

17. A signal relaying method in a relay station apparatus that performs relay and transmission between a first radio communication apparatus and a second radio communication apparatus, the method comprising:
performing error detection on first transmission data transmitted from the first radio communication apparatus and second transmission data transmitted from the second radio communication apparatus, to generate an acknowledgement signal or a negative acknowledgement signal as a response signal;
when a first response signal corresponding to the first transmission data and a second response signal corresponding to the second transmission data are both acknowledgement signals, performing network coding using the first transmission data and the second transmission data to generate relay data; and
transmitting the first response signal, the second response signal and the relay data to the first radio communication apparatus and the second radio communication apparatus.
